(19) United States
(12) Patent Application Publication
(10) Pub. No.: US 2015/0234418 A1
(43) Pub. Date: Aug. 20, 2015

(54) CONTROL DEVICE FOR A FUNCTIONAL DEVICE OF A MOTOR VEHICLE

(71) Applicant: AUDI AG, Ingolstadt (DE)

(72) Inventor: Tahar Bouaziz, Ingolstadt (DE)

(73) Assignee: AUDI AG, Ingolstadt (DE)

(21) Appl. No.: 14/428,531

(22) PCT Filed: Aug. 2, 2013
(86) PCT No.: PCT/EP2013/002315

§ 371 Date: Mar. 17, 2015

(30) Foreign Application Priority Data
Sep. 14, 2012 (DE) 10 2012 018 291.0

(51) Int. Cl. G05G 1/015; G05G 5/03; G05G 1/10

(52) U.S. Cl. CPC G05G 1/015; G05G 1/10; G05G 5/03

(57) ABSTRACT

An operator control device for a functional device of a motor vehicle, includes a rotary actuator which is rotatably mounted on a retaining element and which has at least one coding element. A detection device detects an absolute rotational angle between the rotary actuator and the retaining element on the basis of coding of the at least one coding element. A latching device provides a plurality of latching positions that are predefined for the rotary actuator along a rotational direction. The detection device is designed to detect the respective latching position and the absolute rotational angle between at least two of the latching positions on the basis of the coding of the at least one coding element. A sensor device detects touching of the rotary actuator.

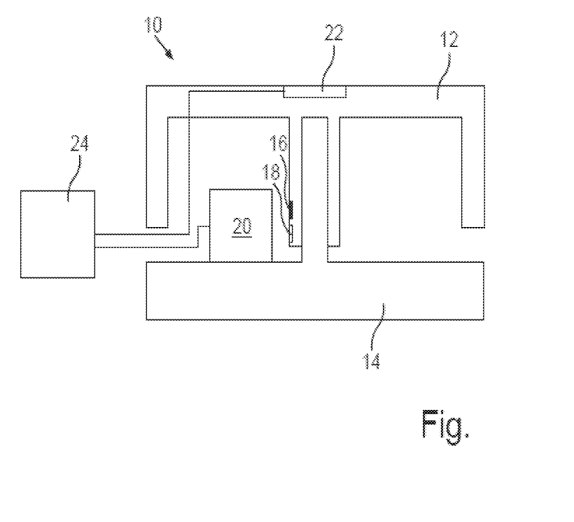

### CROSS REFERENCE TO RELATED APPLICATIONS

This application is based on and hereby claims priority to International Application No. PCT/EP2013/002315 filed on Aug. 2, 2013 and German Application No. 10 2012 018 291.0 filed on Sep. 14, 2012, the contents of which are hereby incorporated by reference.

### BACKGROUND

The present invention relates to an operator control for a functional device of a motor vehicle. Furthermore, the present invention relates to a motor vehicle. Finally, the present invention relates to a method for operating a functional device of a motor vehicle with an operator control.

Corresponding operator controls are provided for operating functional devices of a motor vehicle. Said operator controls can comprise a rotary actuator or rotary encoder. Contemporary rotary actuators have mechanical latching positions in which they latch along their rotational direction. These latching positions are perceived haptically by the user or the operator. An acoustic signal, for example a click, is often additionally output. This type of rotary actuator is widespread and is used, for example, in air-conditioning operator control components or in the central input unit in motor vehicles. As a rule, the rotary actuator is used to switch a discrete function further. For example, in an air-conditioning operator control component the temperature is increased by a predefined temperature per latching stage or the speed of a ventilator is increased.

In graphics-based systems, such as a human/machine interface, the rotary actuator can be used to navigate in the display of the human/machine interface. In this context, adjustment of the rotary actuator by one latching position causes the screen representation to be shifted one step upward or downward. In the case of a navigation system, the map display can be enlarged or reduced in size by adjusting the rotary actuator by one stage.

The latching positions of the rotary actuator are generally generated mechanically with a latching cam or magnetically with magnetic pole pairs. A corresponding electrical value is output with each latching position. That is to say when rotation into the next latching position occurs, an electrical signal is evaluated by a control device in order to determine the rotational direction and the number of latching stages or clicks. This signal is compatible with the haptically perceptible latching stages in which the rotary actuator latches and remains in a stable fashion after the rotation.

The rotary actuators typically have play about the zero position of the respective latching position. After release at a specific position between two latching stages, many rotary actuators do not automatically latch into one of the latching stages and remain between the two latching stages. This can lead to faulty operator operator control signals for the respective functional device of the motor vehicle. For example, when performing operator control on a list, the pointer element can become stuck between two list entries after the rotary actuator has been released.

In this context, DE 196 09 390 A1 discloses an operator control having a plurality of actuator elements for operating various devices in a motor vehicle. The actuating devices each have a sensor element which responds to touch.

DE 10 2004 006 605 A1 describes an operator control for operating a motor vehicle. In this context, an operator control element of the operator control has a touch sensor for detecting touching of the operator control element.

Furthermore, DE 10 2007 024 292 A1 discloses a rotary operator control element for a vehicle air-conditioning system. The rotary operator control element has a sensor unit for detecting rotation of the rotary operator control element. An acoustic signal in the form of latching noises is output as a function of the rotation of the rotary operator control element.

DE 10 2009 006 448 A1 describes a method for determining a sitting position of an occupant in a vehicle on the basis of activation of an operator control element of the vehicle. Functional devices in the vehicle are set for the driver or the front seat passenger as a function of the detected sitting position. For this purpose, the operator control element has a capacitive sensor with which it is possible to detect whether a part of the body is approaching from the driver's side or the front seat passenger's side.

In addition, DE 10 2010 010 574 A1 discloses a rotary actuator for a vehicle, which rotary actuator has a touch-sensitive surface. By evaluating the signals of the touch-sensitive surface it is possible to use touching and activation of the rotary actuator to control functions.

Finally, DE 10 2008 057 098 A1 describes a rotary actuator for a vehicle, which rotary actuator has a latching system and a movement detection system. With a sensor device of the rotary actuator it is possible to detect the rotational direction and the rotational angle of an actuating element.

### SUMMARY

The object of the present invention is to make available an operator control of the type mentioned at the beginning which can be operated more easily and reliably.

This object is achieved by means of an operator control having the features of patent claim 1 and by a motor vehicle having the features of patent claim 9. In the same way, this object is achieved by a method having the features of patent claim 10. Advantageous developments of the present invention are specified in the dependent claims.

The operator control according to the invention for a functional device of a motor vehicle comprises a rotary actuator which is rotatably mounted on a retaining element and which has at least one coding element, a detection device for detecting an absolute rotational angle between the rotary actuator and the retaining element on the basis of coding of the at least one coding element, and a latching device by means of which a plurality of latching positions are predefined for the rotary actuator along a rotational direction, wherein the detection device is designed to detect the respective latching position and the absolute rotational angle between at least two of the latching positions on the basis of the coding of the at least one coding element, and wherein the operator control comprises a sensor device for detecting touching of the rotary actuator.

The operator control can be arranged in the dashboard or in the center console of the motor vehicle. The motor vehicle can also comprise a plurality of operator controls with which functional devices such as, for example, an air-conditioning system, a navigation system, an operator control with associated display, an entertainment system or the like can be actuated. The operator control comprises a rotary actuator which can also be embodied as a push and turn actuator. Furthermore, the operator control comprises a latching device which predefines a plurality of latching stages or latching positions for the rotary actuator. These latching positions can be generated mechanically with a latching cam or by corresponding magnets. When the rotary actuator rotates, it latches in the latching positions.

At least one coding element is arranged on the rotary actuator. The at least one coding element preferably extends along the circumferential direction of the rotary actuator or of a shaft of the rotary actuator. In addition, the operator control comprises a detection device which can comprise a sensor. Furthermore, the detection device can be arranged fixedly on the retaining element or a housing of the operator control. As a result of the coding of the at least one coding element, a corresponding output signal is generated in the detection device. This coding element can comprise, for example, one or more magnets, and the detection device can comprise a magnetic sensor, for example a Hall sensor. Alternatively, the coding element can have cutouts or a predetermined geometry which can be sensed with an optical sensor of the detection device. The use of slip contacts is also conceivable.

The detection device of the operator control is then embodied to detect individually the predefined latching positions on the basis of the coding of the at least one coding element. The latching stages therefore no longer have to be evaluated electronically on an individual basis. In addition, with the detection device the absolute rotational angle between at least two latching positions can be detected. In addition, with the detection device it is possible to detect the rotational direction of the rotary actuator on the basis of the coding of the at least one coding element. The discrete latching positions which bring about a high-value operator control sensation for the user through the haptic feedback are present on the operator control. Furthermore, slight deflections of the rotary actuator can be detected with the detection device before the latching into the next latching position. As a result, it is easily possible to detect not only the latching positions but also the intermediate positions between the latching stages with high resolution, and to further process them correspondingly.

In addition, the operator control comprises a sensor device with which touching of the rotary actuator is detected. It is therefore possible to take into account whether or not an operator is currently operating the operator control. As a result, an operator control process of the operator control can be detected more reliably.

The operator control preferably comprises a control device which is coupled to the detection device and the sensor device and which outputs, as a function of the detected latching position, the detected absolute rotational angle between the at least two latching positions and/or the detected touching of the rotary actuator, a control signal for operating the functional device. Therefore, not only the discrete latching positions but also the intermediate positions of the rotary actuator between the latching positions can be used to actuate a functional device of the motor vehicle. Furthermore, it is possible to take into account whether or not the user touches the rotary actuator. In this context, it is also possible to take into account the duration of the touching of the rotary actuator. Alternatively or additionally, the touching of the rotary actuator can be detected at different regions of the rotary actuator. For this purpose, the sensor device can comprise a plurality of individual sensors which are arranged distributed on the outer surface of the rotary actuator. An undesired operator control process of the rotary actuator can therefore be detected better.

In one refinement, the control device outputs a respective latching control signal for each of the detected latching positions.

In a further embodiment, the control device outputs at least one intermediate control signal as a function of the detected absolute rotational angle between the at least two latching positions. If the rotary actuator is located between two latching stages, depending on the rotational angle a corresponding intermediate control signal can be output as the control signal. A plurality of intermediate stages can also be provided between the latching stages, wherein each intermediate stage is assigned an intermediate control signal. As a result, control of the functional device of the motor vehicle can be made possible even in the case of a position or movement of the actuator between two discrete latching positions.

The control device preferably outputs a latching control signal irrespective of whether the sensor device detects touching of the rotary actuator. If the rotary actuator latches onto a predefined latching position, it is located in a defined operating state. In this case, a corresponding control signal can be output if the operator instantaneously touches the rotary actuator or if the operator does not touch (no longer touches) the rotary actuator.

In a further embodiment, the control device outputs an intermediate control signal only if the sensor device detects touching of the rotary actuator. If the operator does not instantaneously operate the rotary actuator and if the rotary actuator is located between two latching positions, an operating state cannot be reliably assigned to the rotary actuator. For this reason, a control signal is output in an intermediate position between two of the latching positions only if the user touches the rotary actuator or operates it instantaneously. This makes possible a reliable operator control process.

In one refinement, the control device detects the closest of the latching positions on the basis of the detected absolute rotary angle and outputs the latching control signal for the closest of the latching positions if the sensor device does not detect touching of the rotary actuator. If the operator does not instantaneously operate the rotary actuator, the control device can determine the latching position which is closest to the instantaneous position of the rotary actuator and output the latching signal and a control signal which is as if the rotary actuator were located in this latching position. As an alternative to the position of the rotary actuator, the rotational speed or a change in the rotational speed can also be used to determine a latching position if the rotary actuator is instantaneously not being touched. For example, a threshold value can be predefined for the rotational speed and/or the change in the rotational speed. If this threshold value is exceeded it is possible to assume that the operator wished to or would like to rotate the rotary actuator into the subsequent latching position in the rotational direction, even if after the release the rotary actuator is closer to the latching position which is the preceding one in the rotational direction. As a result, a reliable operator control process can be made possible with the operator control.

In a further refinement, the sensor device comprises an optical sensor and/or a capacitive sensor. The sensor device can also comprise a plurality of these sensors which are arranged on the outer face of the rotary actuator. Touching of the rotary actuator can therefore be reliably detected and the functional device can be operated.

The motor vehicle according to the invention comprises the operator control described above.

Finally, according to the invention a method for operating a functional device of a motor vehicle with an operator control is made available, wherein the operator control comprises a rotary actuator which is rotatably mounted on a retaining element and which has at least one coding element, by detecting an absolute rotational angle between the rotary actuator and the retaining element on the basis of coding of the at least one coding element, predefining a plurality of latching positions for the rotary actuator along its rotational direction, detecting the respective latching position and the absolute rotational angle between at least two of the latching positions on the basis of the coding of the at least one coding element, and detecting touching of the rotary actuator.

The advantages and developments which are described above in relation to the operator control according to the invention apply in the same way to the motor vehicle according to the invention and the method according to the invention.

### BRIEF DESCRIPTION OF THE DRAWING

These and other objects and advantages of the present invention will become more apparent and more readily appreciated from the following description of the preferred embodiments, taken in conjunction with the accompanying drawing:

The single figure shows a schematic illustration of an operator control in a sectional side view.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The figure shows a schematic illustration of an operator control 10 in a sectional side view. The operator control 10 serves to operate a functional device of a motor vehicle. Such a functional device can be an air-conditioning system, a navigation system, an operator control with associated display, an entertainment system or the like. The operator control 10 comprises a rotary actuator 12 which is rotatably mounted on a retaining element 14. Furthermore, two coding elements 16 and 18 are arranged on the rotary actuator 12. The coding elements 16, 18 can comprise one or more magnets. Alternatively, the coding elements 16, 18 can comprise electrical contacts. In a further embodiment, the coding elements 16, 18 can comprise corresponding cutouts.

Furthermore, the operator control 10 comprises a detection device 20 which is securely connected to the retaining element 14 in a mechanical fashion. The detection device 20 can comprise a corresponding sensor element which interacts with the coding elements 16, 18 in such a way that the detection device 20 makes available an output signal in each case as a function of coding of the coding elements 16, 18. If the coding elements 16, 18 comprise magnets, the detection device 20 can have a magnetic sensor, for example a Hall sensor. If the coding elements 16, 18 have electrical contacts, the detection device 20 can comprise slip contacts. If the coding elements 16, 18 are formed by cutouts, the detection device 20 can comprise an optical sensor. The operator control 10 additionally has a latching device (not illustrated here) which predefines latching positions for the rotary actuator 12.

As a result of the rotation of the rotary actuator 12, at least two output signals are generated by the two coding elements 16 and 18 in the detection device 20. In this context, the coding elements 16, 18 can be embodied in such a way that two output signals are produced which have a substantially continuous or analog profile. The output signals can also be offset with respect to one another along the rotational direction. In order to evaluate these analog output signals it is possible to predefine a threshold value in each case. The rotational direction and the individual latching positions can be determined as a function of the threshold value being exceeded or undershot. Furthermore, the rotational angle between at least two latching positions can be determined on the basis of the output signals. The respective amplitude of the output signal is used to determine the rotational angle in a range between at least two latching positions.

Three coding elements 16, 18 can also be used, wherein the coding elements 16, 18 can be configured here such that as a result of the detection of two of the three coding elements 16, 18 the detection device 20 outputs a digital output signal in each case. The rotational direction and the individual can be determined on the basis of the digital output signals. An output signal which has a continuous or analog profile is output by the detection device 20 as a result of the evaluation of the third of the three coding elements 16, 18. The rotational angle between two of the latching positions can be determined on the basis of the output signal.

Furthermore, the operator control 10 comprises a sensor device 22 with which touching of the rotary actuator 12 can be detected. For this purpose, the sensor device 22 can comprise one or more sensors which are arranged along the outer face of the rotary actuator 12. This sensor device 22 can comprise capacitive and/or optical sensors. In addition, the operator control 10 comprises a control device 24 which is coupled to the detection device 20 and the sensor device 22. The control device 24 is coupled to the functional device (not illustrated here) of the motor vehicle and can transmit corresponding control signals thereto. These control signals are calculated as a function of the signals of the detection device 20 and of the sensor device 22.

If the rotary actuator 12 is in a predefined latching position, a latching control signal is generated by the control device. This signal is generated irrespective of whether or not the control device 22 detects touching of the rotary actuator 12. If the rotary actuator 12 is located in a range between two latching positions, an intermediate control signal is output with the control device 24. This intermediate control signal is, however, output only if touching of the rotary actuator 12 is detected with the sensor device 22.

The control device 24 is designed to determine the latching position which is closest to the rotary actuator 12 in the event of touching of the rotary actuator 12 not being detected with the sensor device 22 and the rotary actuator 12 being located between two of the latching positions. If the rotary actuator 12 is not touched between two latching positions, the latching control signal which is assigned to the closest latching position is output with the control device 24. This permits a reliable operator control process of the operator control 10.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. An operator control device for a functional device of a motor vehicle, comprising:
a retaining element;
a rotary actuator which is rotatably mounted on the retaining element and which has at least one coding element;
a latching device to produce a plurality of predefined latching positions for the rotary actuator along a rotational direction;
a detection device to detect a current latching position of the rotary actuator and to detect an absolute rotational angle between the rotary actuator and the retaining element, the absolute rotational angle being an absolute rotational angle between at least two of the latching positions, the current latching position and the absolute rotational angle being detected based on a coding of the at least one coding element;
a sensor device to detect touching of the rotary actuator; and
a control device to output a control signal for operating the functional device, wherein
when the rotary actuator is between two latching positions, the control device detects a more proximate latching position of the two latching positions, based on the detected absolute rotational angle,
the control device outputs an intermediate control signal as a function of the absolute rotational angle between the at least two latching positions, the intermediate control signal being output if the sensor device detects touching of the rotary actuator, and
the control device outputs a latching control signal corresponding to the more proximate latching position if the sensor device does not detect touching of the rotary actuator.

12. An operator control device for a functional device of a motor vehicle, comprising:
a retaining element;
a rotary actuator which is rotatably mounted on the retaining element and which has at least one coding element;
a latching device to produce a plurality of predefined latching positions for the rotary actuator along a rotational direction;
a detection device to detect a current latching position of the rotary actuator and to detect an absolute rotational angle between the rotary actuator and the retaining element, the absolute rotational angle being an absolute rotational angle between at least two of the latching positions, the current latching position and the absolute rotational angle being detected based on a coding of the at least one coding element; and
a sensor device to detect touching of the rotary actuator.

13. The operator control device as claimed in claim 12, wherein
a control device is coupled to the detection device and the sensor device,
the control device outputs a control signal for operating the functional device, and
the control signal is output as a function of at least one of a detected latching position, a detected absolute rotational angle between the at least two latching positions and a detected touching of the rotary actuator.

14. The operator control device as claimed in claim 13, wherein
the control device outputs a respective latching control signal for each detected latching position.

15. The operator control device as claimed in claim 13, wherein
the control device outputs an intermediate control signal as a function of the detected absolute rotational angle between the at least two latching positions.

16. The operator control device as claimed in claim 14, wherein
the control device outputs the latching control signal irrespective of whether the sensor device detects touching of the rotary actuator.

17. The operator control device as claimed in claim 15, wherein
the control device outputs the intermediate control signal only if the sensor device detects touching of the rotary actuator.

18. The operator control device as claimed in claim 15, wherein
when the rotary actuator is between two latching positions, the control device detects a more proximate latching position of the two latching positions, based on the detected absolute rotational angle, and
the control device outputs a latching control signal corresponding to the more proximate latching position if the sensor device does not detect touching of the rotary actuator.

19. The operator control device as claimed in claim 15, wherein
when the rotary actuator is between two latching positions, the control device detects a more proximate latching position of the two latching positions, based on the detected absolute rotational angle,
the control device outputs the intermediate control signal as a function of the detected absolute rotational angle if the sensor device detects touching of the rotary actuator, and
the control device outputs a latching control signal corresponding to the more proximate latching position if the sensor device does not detect touching of the rotary actuator.

20. The operator control device as claimed in claim 13, wherein
when the sensor device detects touching of the rotary actuator, the control device outputs a continuous control signal having an analog profile, as a function of the detected latching position and as a function of the detected absolute rotational angle between the at least two latching positions.

21. The operator control device as claimed in claim 22, wherein
the sensor device comprises an optical sensor and/or a capacitive sensor.

22. The operator control device as claimed in claim 12, wherein
the rotary actuator is a push-turn actuator such that the rotary actuator is rotatable in the rotational direction and laterally movable toward and away from the retaining element, and
the detection device further detects lateral movement of the rotary actuator.

23. The operator control device as claimed in claim 12, wherein
the detection device further detects a rotational direction of the retaining element.

24. The operator control device as claimed in claim 12, wherein
a plurality or coding elements are provided, extending in a circumferential direction from the rotary actuator of a shaft of the rotary actuator,
the coding elements are selected from the group consisting of magnets, electrical contacts and cutouts, and
the detection device comprises a detector selected from the group consisting of a Hall sensor, slip contacts and an optical sensor.

25. The operator control device as claimed in claim 12, wherein
the functional device is selected from the group consisting of a navigation system, an air conditioning system and an entertainment system.

26. A motor vehicle comprising the operator control device as claimed in claim 12.

27. A method for operating a functional device of a motor vehicle using an operator control device, the operator control device comprising a rotary actuator which is rotatably mounted on a retaining element and which has at least one coding element, the method comprising:
predefining a plurality of latching positions for the rotary actuator along a rotational direction;
detecting a current latching position of the rotary actuator based on coding of the at least one coding element;
detecting an absolute rotational angle between the rotary actuator and the retaining element, the absolute rotational angle being an absolute rotational angle between at least two of the latching positions, the absolute rotational angle being detected based on the coding of the at least one coding element; and
detecting touching of the rotary actuator.

28. The method as claimed in claim 27, further comprising:
detecting a rotational speed of the rotary actuator or a change in rotational speed of the rotary actuator;
determining whether the rotational speed of the rotary actuator or the change in the rotational speed of the rotary actuator exceeds a threshold; and
if the threshold has been exceeded, controlling the functional device based on an assumption that an operator intended to rotate the rotary actuator to a subsequent rotational position.
